(19) United States
(12) Patent Application Publication
(10) Pub. No.: US 2003/0108804 A1
(43) Pub. Date: Jun. 12, 2003

(54) Inkjet manufacturing process and device for color filters

(76) Inventors: Kevin Cheng, Hsinchu (TW); Jupiter Tsai, Taipei Hsien (TW); Jessen Chen, Nantou Hsien (TW); Tz-Ya Yang, Taipei (TW); Jane Chang, Hsinchu Hsien (TW)

Correspondence Address: BIRCH STEWART KOLASCH & BIRCH, PO BOX 747, FALLS CHURCH, VA, 22040-0747, US

(21) Appl. No.: 10/087,740

(22) Filed: Mar. 5, 2002

(30) Foreign Application Priority Data
Dec. 11, 2001 (TW) 90130599

(51) Int. Cl. G02B 5/20

(52) U.S. Cl. 430/7; 347/20; 347/1; 427/164; 347/107

(57) ABSTRACT

An inkjet manufacturing process and device for color filters are disclosed. The invention includes an inkjet head module, a motion platform, an electric field generator, an optical detection system, and a control system. The motion platform can support a filter substrate and have relative motion with respect to the inkjet head module. The optical detection system provides a real-time positioning function so that the inkjet head module can correctly jet and paint ink droplets on the substrate. The electric field generator imposes an electric field on the ink droplets so that the ink droplets become homogeneous because of the electrocapillary effect. The invention avoids the usual design of an ink absorption layer, greatly increasing the accuracy and diffusion homogeneity of the ink droplet painting.

### BACKGROUND OF THE INVENTION

1. Field of Invention

The invention relates to an inkjet manufacturing process and device for color filters. In particular, it relates to an inkjet manufacturing process and device for making color filters that have a real-time correction positioning function and can equalize ink droplets through an imposed electric field.

2. Related Art

Color filters are mainly used in three aspects: first, they are used in image sensors, e.g. CCD's (charge coupled device); secondly, they are used in line sensors, e.g. crystal shutters; and thirdly, they are used in displays, e.g. TN (Twisted Nematic) and STN (Super Twisted Nematic) TFT (thin film transistor) LCD's (liquid crystal display). With the demand growth of these products, demands for color filters also increase. Therefore, lowering the manufacturing cost of color filters becomes an important subject in the field.

Conventional color filter manufacturing processes can be categorized into four types. They all require relatively complicated procedures, including coloring, cleaning, drying, developing and etching. Therefore, it is indeed difficult to lower the manufacturing cost. In order to further lower the cost, the main technique breakthrough is the invention of inkjet manufacturing process. The inkjet manufacturing process directly put ink droplets into a black matrix of concavities on a filter substrate. Different types of filters have different color painting patterns. Normally, the red, green and blue (RGB) colors are taken as a basic pixel element. In comparison with other semiconductor manufacturing processes, this inkjet manufacturing process has a relatively lower cost in devices, materials and manufacturing.

However, the inkjet method has to have precise positioning so that the ink droplets can be printed at predetermined positions and no white omissions occur. In general, an optical correction method is utilized to provide precise positioning. The prior art uses the design of an ink absorption layer, which is a thin ink absorption layer inside the concavities of a filter substrate so that the ink droplets are printed. The diffusion ability of the ink absorption layer limits the distribution of the ink droplets to desired areas.

These methods mentioned above still have a lot of problems to be solved. First, the design of an ink absorption layer increases the cost and manufacturing procedures. After the ink droplets are diffused into the ink absorption layer, the diffusion ability of the ink absorption layer and the accuracy of the droplet landing position limit the distribution of the ink droplets to desired area, it results white omissions or color mixings among the concavities. It seriously deteriorates the quality of color filters. Furthermore, the optical system used for position detection either is non-real-time correction as printing, or it analyzes the real-time analog signal to determine the position offset. That is, they determined the position offset by the light intensity distribution of sensors. However, the light intensity distribution may have shifts due to the error in the relative position of the light source and the sensor so that the locations of the troughs and crests in sensors cannot be accurately mapping. In addition, the detection sensor and the inkjet print head are made together. Aside from the issue of a higher cost, the print head cannot be cleaned when it is clogged (it will make the sensor dirty). Therefore, the usage of the nozzles on the print head is lowered.

### SUMMARY OF THE INVENTION

To solve the above-mentioned problems, the invention provides an inkjet manufacturing process and device for color filters. They can provide real-time correction positioning so that the application of ink droplets becomes more accurate. An electric field is further applied to equalize the ink droplets on the substrate, to modify the droplet profile and make better wettability. This wetting behavior is instead the ink absorption layer design in the prior art. Therefore, the invention is greatly lower the manufacturing process and cost.

The disclosed inkjet device for color filters includes an electric field generator, a motion platform, an inkjet print head module, an optical detection system and a control system. The motion platform supports a color filter substrate. The black matrix on the substrate forms a lattice structure for accommodating ink droplets. The function of the black matrix is to prevent color mixing and increase the sharpness of color. A layer of photo resister then coat above the black matrix to build the shield wall to prevent the ink droplet sputtering. The optical detection system detects the relation position offset of the lattice structure on the filter substrate and the inkjet print head module. It corrects the relative position between the filter substrate and the inkjet print head nozzles immediately, achieving precision painting. The light source of the optical detection system is provided under the filter substrate, the detector directly measures the intensity of the light penetrating through the substrate. This analog signal on the detector (e.g. CCD) is then converted into a digital signal for accurately determining the central position of the lattice structure. After ink droplets are landed on the substrate, the electric field generator imposes an electric field (AC or DC) on the ink droplets so that the droplets experience the electrocapillary effect and homogeneously distribute themselves in the allowed lattice range. The invention thus achieves a better ink droplet distribution without an ink absorption layer. According to the disclosed manufacturing process, an electrode is first implanted on a filter substrate. The implantation position can be on the top or bottom surface of the filter substrate. In printing process, after the ink droplets are discharged, an electric field applied on the ink droplets to homogeneously distribute the ink droplets within the lattice frame. Finally, the ink on the substrate is dried and cured.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the invention;

FIG. 2 is a schematic view showing the procedure of the invention;

FIGS. 3A and 3B are schematic view of the first embodiment of the disclosed lattice;

FIGS. 4A and 4B are schematic view of the second embodiment of the disclosed lattice;

FIGS. 5A through 5F show the steps in the procedure of the invention;

FIGS. 6A through 6C are schematic views of the invention;

FIGS. 7A and 7B are schematic view of the actions of the disclosed altitude adjustment unit; and

FIG. 8A through 8C are schematic views of the relation between the ink droplet surface tension and the electric energy.

### DETAILED DESCRIPTION OF THE INVENTION

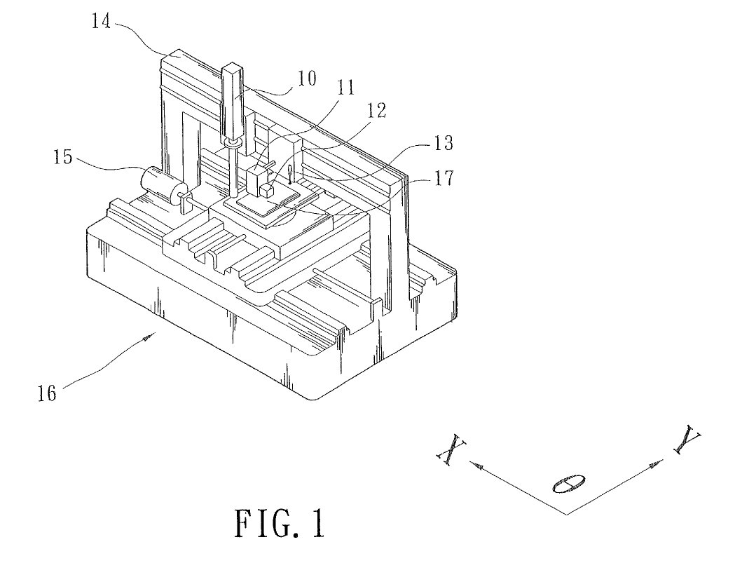

As shown in FIG. 1, the disclosed inkjet manufacturing device for color filters includes an inkjet print head module 11, a motion platform 16, an electric field generator 12, an optical detection system and a control system. The print head module 11 has at least one nozzle for each color (Red, Green and Blue). Each color is a distinct print head for print ink droplets on a substrate 17. The motion platform 16 supports the substrate 17 for the print head module 11 to discharge ink. A supporting frame 14 is provided for installing the inkjet print head module 11. A driving motor 15 is provided to make the supporting frame 14 move along the X-Y-θ directions with respect to the inkjet print head module 11.

The optical detection system contains a first optical module 13 and a second optical module 10 to detect the relative positions of the substrate 17 and the inkjet print head module 11. The first optical module 13, which can be an area CCD, is used to detect the position of the substrate 17. The second optical module 10, which can be a linear CCD, is used to detect the relative position shift of the nozzle of the inkjet print head module 11 and the track of the ink droplets to be explained later. That is, the first optical module 13 provides a preliminary positioning correction and the second optical module 10 provides real-time and precision positioning.

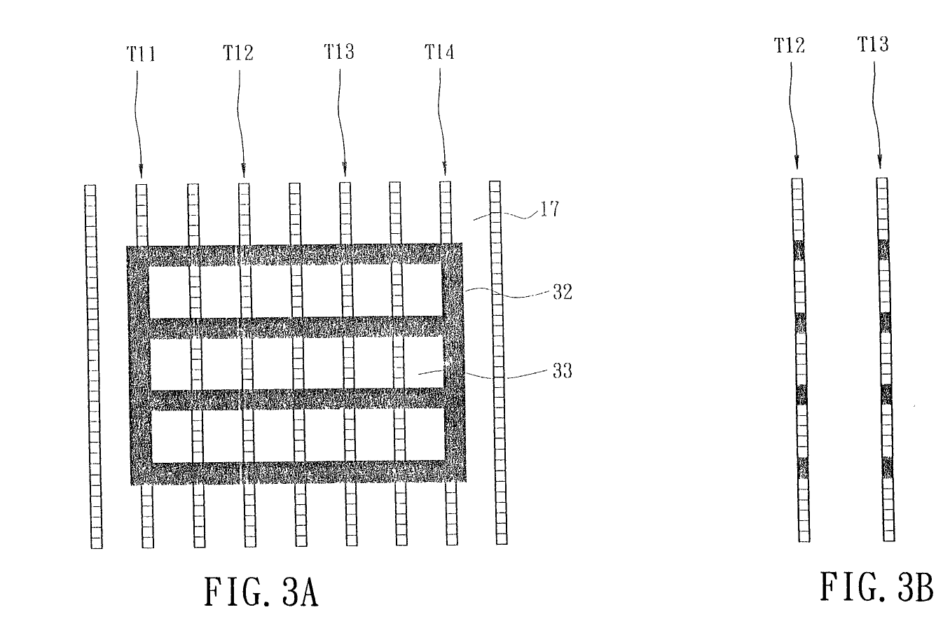

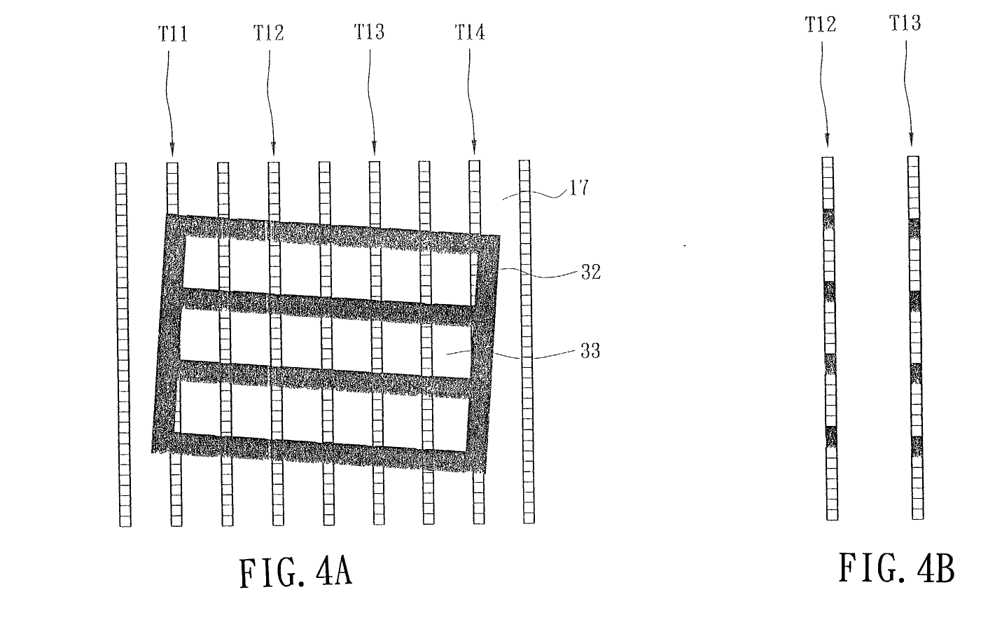

The correction and positioning of the position and angle of the print head relative to the substrate 17 is shown in FIG. 3A. The light intensity from the light source (not shown in the figs) under the substrate through the substrate 17 is measured by the second optical module 10. The light source can be a pointer light source or a back light source and the first optical module 13 can use the same design. For position determination, the light intensity is converted into a digital signal. For example, if the intensity is over a threshold, then the area that needs to be colored within a printing frame is set as 1. On the other hand, if the intensity is lower than the threshold, then the area is marked as 0, for example the border of the printing frame 32. The light from the light source merges from under the substrate 17. The light signal can project through the paint area but block by the printing frame 32. The signals detected by the second optical module 10 at different times are T11, T12, T13 and T14. Since the size of the printing frame 32 is fixed, it can be set in advance so that if the percentage of the signal 0 is over a predetermined threshold (e.g. over 60%) in the detecting track, then it is the border T11 of the printing frame 32. Between a border T11 and a next border T13 is the paint area 33. The printing frame 32 can be a two-dimensional black matrix. The rest detecting tracks T12, T13 are used to determine the deviated angle of the printing frame 32. As shown in FIG. 3B, the black area of the received signal by the second optical module 10 is 0, i.e. the penetrated light intensity is below the threshold value. By determining the positions of the signal 0 in T12 and T13, the skew of the printing frame 32 can be measured. As shown in FIGS. 4A and 4B, the skew angle of the printing frame can be read from the detection signals T12, T13. The deviated angle is computed according to the distance between two tracks, the motor speed, and the mapping physical size of each CCD pixel in the optical systems. The control system then controls the driving motor 15 to make corrections. Of course, there may be more than four detection tracks in a printing frame 32.

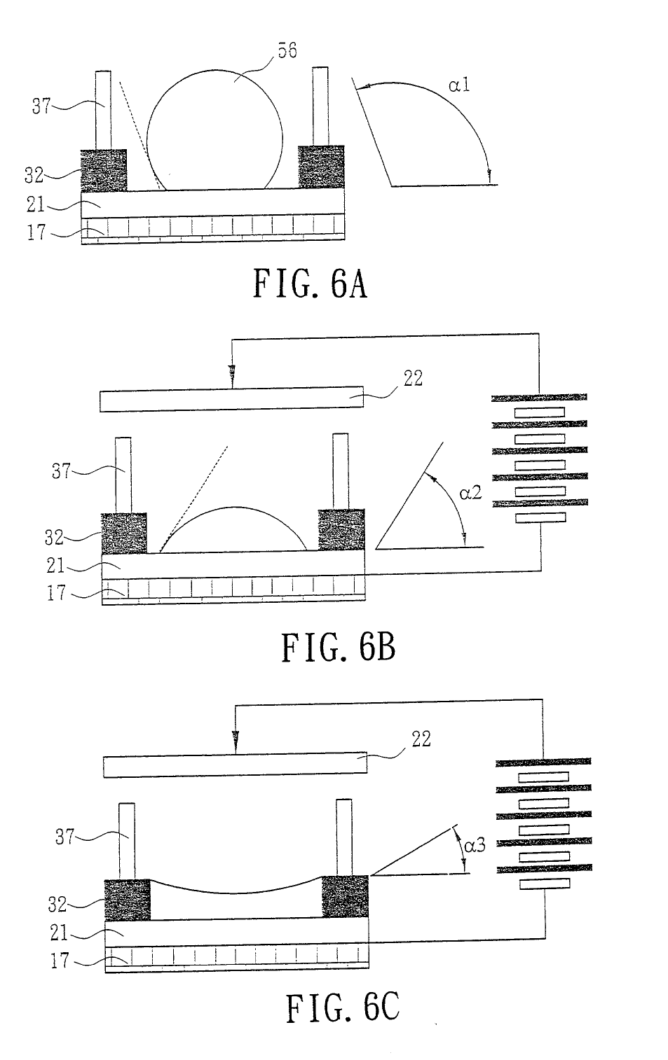

After ink droplets 56 are painted, the electric field generator 12 imposes an electric field on them so that the ink droplets 56 are homogenized by the electrocapillary effect. With reference to FIG. 6A, when an ink droplet 56 falls on the surface of substrate 17, or the surface of an electrode 21 because the top or bottom surface of the substrate 17 has to be implanted with an electrode 17 for producing the electrocapillary effect, an obtuse contact angle α₁ forms at the surface due to the surface tension. Another electrode 22 (DC or AC) is used to impose an electric field on the ink droplet 56. Because of the electrocapillary effect the ink droplet 56 becomes flatter and the contact angle gets smaller to become an acute angle α₂ (see FIG. 6B). Continuing to supply a current or enhancing the electric field intensity will eventually homogeneously distribute the ink droplet 56 (FIG. 6C) so that the contact angle becomes even smaller as α₃.

To produce the electrocapillary effect, the ink droplet 56 has to be conductive so that the ink droplet surface changes its surface tension due to the charge distribution (positively charged ions or negatively charged electrons), achieving a flat surface. The composition of the ink droplet 56 can be pigments, dyes, pigment dispersions, binders, solvents, aqueous fluid, surfactants, viscosity modifiers, dye solubilizers, chelation agents, UV blockers (for increasing the UV resistance), UV initiator, electrolyte, small particles with positive or negative charges and their combinations. The solvents mentioned herein can be the commonly used methanol, methyl ethyl ketone, ethyleneglycol methyl ether, alcohol, glycol, oils, deionized water, methyl ester of resin, styrene-acrylic acid co-polymer, dimethylamine hydrochloride, nonyl-phenoxpolyethoxy ethanol, 1-methyl2pyrrolidone, propyleneglycol monomethyl ether, O-butyl benzyl phthalate, potassium thiocyanate, fluorchemical FC170C, or a solvent for piezoelectric or thermal inkjet printing. The dyes are currently available dyes. They can be used individually or together by thermal, photo or chemical reactions. The small charged particles refer to particles with various charges, shapes, sizes, densities, surface properties, optical properties, and organic/inorganic chemicals to be added into the ink to improve the ink properties. A typical example is to add small pigment/dye particles into the ink to improve the electric properties of the ink. Such pigment particles may be selected from, for instance, the commonly used rutile (Titania), natase (Titania), barium sulfate, kaolin, or zinc oxide. Possible choices of pigments include PbCrO.sub.4, cyan blue GT 55-3295 (American Cyanamid Company, Wayne, N.J.), sevron brilliant red 3 B (DuPont), azosol brilliant blue B (GAF, Dyestuff and Chemical Division, Wayne, N.J.), rubanox red CP-1495 (The Sherwin-Williams Company, Cleveland, Ohio) (15630), but there is no limitation on the pigment selection. Since this part of the invention is mostly known in the prior art, it is not explained in further detail.

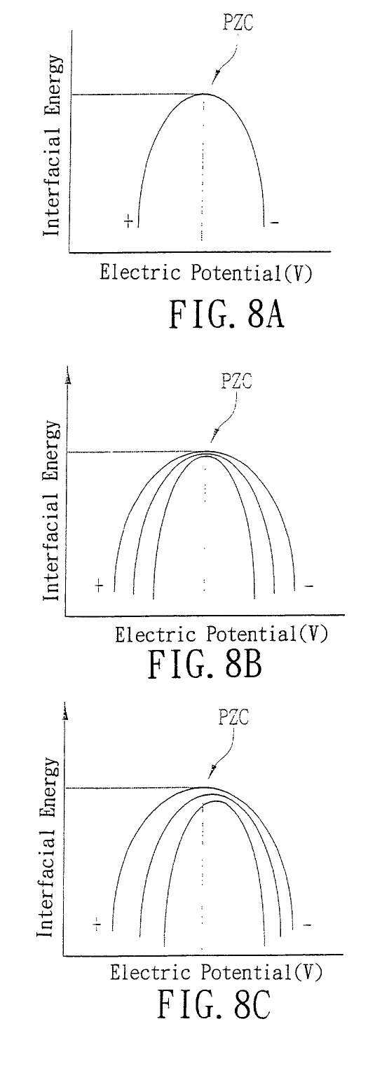

The intensity of the imposed electric field is affected by such factors as the surface roughness and material of the substrate 17 and the properties and mobility of the ink droplets 56. These factors determined the contact angle of the ink droplets 56 on the substrate 17. The distribution is schematically shown in FIG. 8A. The anions and cations in the ink droplets 56 at the PZC (point of zero charge) are not attracted or repelled by the electric field. The surface energy of the ink droplet 56 and the imposed electric potential have the following relation:

γ(V)=γ₀−ε/2dV²,

where γ is the surface energy, V is the imposed electric potential, γ₀ is the surface energy at the PZC, ε is the permittivity, and d is the distance between two electrodes.

The way to generate an electric field can be such that one of the electrodes 21, 22 is grounded and the other is positively or negatively charged. Alternatively, the configuration can be such that one of the electrodes 21, 22 is positively charged while the other being negatively charged. Charging the capacitance (ε/d) also changes the surface energy at the PZC, as shown in FIG. 8B. In this invention, the capacitance can be adjusted by a height adjustment unit 23. In some cases, the fluid properties due to hydration (e.g. CuSO₄+5H₂O=CuSO₄.5H₂O) will make part of the anions stay on the fluid surface. Therefore, one needs to impose a larger negative voltage to repel anions away from the fluid surface in order to maintain the PZC intact (see FIG. 8C).

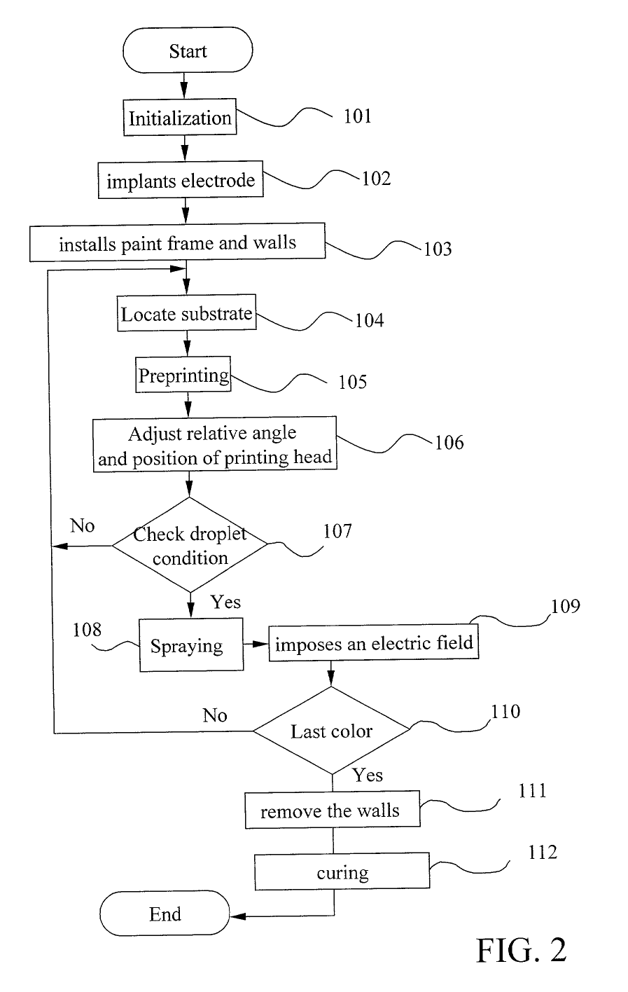

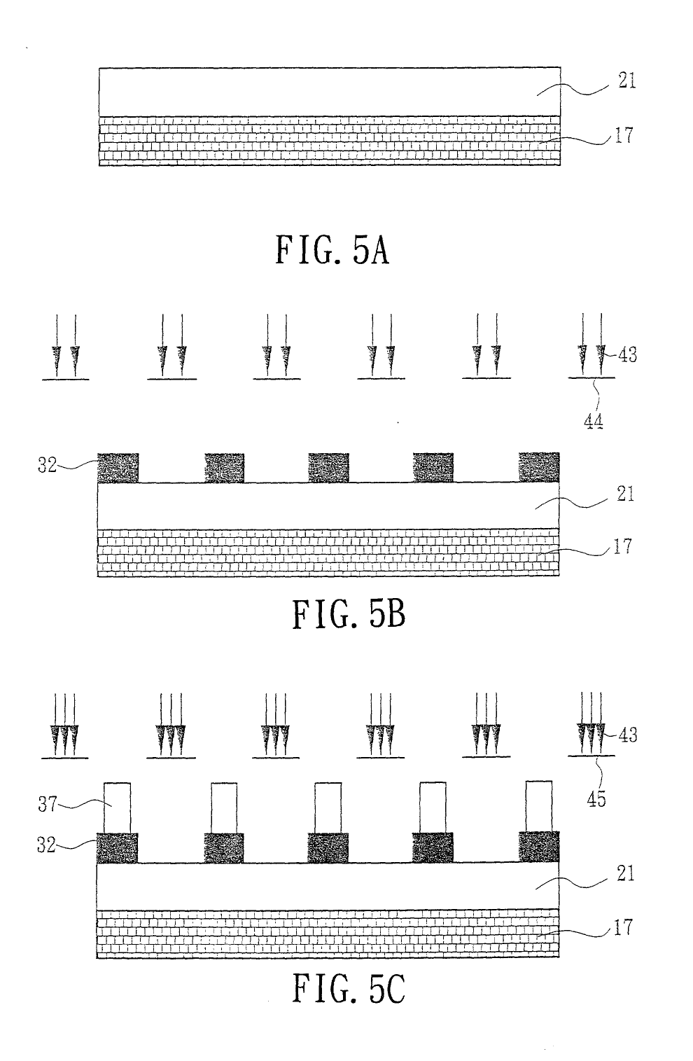

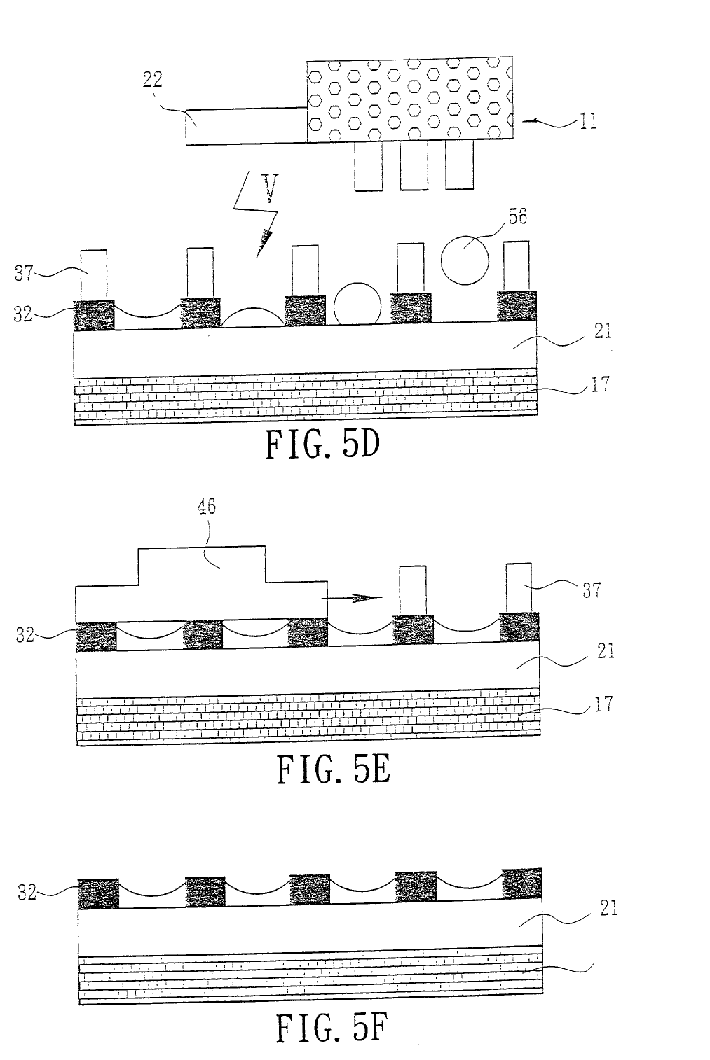

With reference to FIG. 2, step 101 first initializes the inkjet device for color filters. Step 102 implants electrodes on the substrate 17. As shown in FIG. 5A, the implanted electrode 21 can be indium/tin oxide (ITO). However, other conductive materials may also be used so far as it does not impair the transparency of the resulting color filter layer and has properties required of the color filter. The implanted electrode 21 can be formed by coating a conductive material on the substrate 17 or coating the substrate 17 on the electrode 21. The difference between these two methods is that the former has the problem of an uneven surface, while the later increases the distance between the electrodes so that a larger driving current is required.

Afterwards, step 103 coats printing frame and shield wall structure. As shown in FIG. 5B, a printing frame 32, such as two-dimensional black matrix (BM), is generated by forming a thin film on a substrate 21 by sputtering and performing patterning by photolithography process so as to have opening portions (pixel portions). The pattern exposure using a first photo-mask 44 and photo energy 43 are performed for printing frame 32. The thickness of the printing frame 32 is preferably from 0.5 to 2 μm. The material of BM can compose of a colored resin, metal or metal oxide, or may be a multi-layer film formed of a metal oxide film and a metal film. It is also preferred the carbon black or a pigment be dispersed in the resin. Other examples of the metal used for the printing frame 32 include chromium, zirconium, tantalum and molybdenum, while preferable examples of the metal oxide used include oxides of above-mentioned metals. In the case of the metal or metal oxide, its thickness is preferably from 0.5 to 1 μm.

Similarly, a second photo mask 45 is used to form a shield wall 37 on the printing frame 32 (FIG. 5C) to avoid the sputtering of the ink droplet 56. The shield wall 37 is made as water-repellent material or same as black matrix, it is made water-repellent by containing a component having lipophilic functional group in a resin where the printing frame 32 is formed of resin, or by keeping surface of a metal clean where the printing frame 32 is formed of metal. In the case, the surface of the printing frame 32 is also made water-repellent by using a coupling agent. It should be noted that these two photo-masks 44,45 to form the printing frame 32 and the shield wall 37 have different pattern. Taking into consideration the fact that a relatively large amount of ink need to be discharged in order to prevent the generating of an uncolored portion at the boundary portion between the printing frame 32 and the shield wall 37, it is preferable to use a photo-mask pattern having an opening portion smaller than the width of the printing frame 32. The photo-mask pattern of the printing frame 32, it opening width is ˜23 μm, and that of the shield wall is ˜15 μm. Besides, the thickness of the printing frame 32 and the shield wall 37 are different, the thickness for printing frame 32 is as mentioned before, and the thickness for shield wall 37 is typical about 20 μm.

The first optical module 13 performs rough positioning for the substrate 17 (step 104). That is, the inkjet area of the substrate 17 is roughly positioned under the nozzle of the inkjet print head module 11 and a predetermined color is printing (step 105). This step is performed by moving a reference nozzle to a white area on the substrate 17, and the relative position and angle of the print head is appropriately adjusted (step 106). After the reference nozzle printed the color to the substrate 17, the first optical module 13 detects the color and a template color, checking whether the painted ink droplet is normal and acceptable (step 107). If it is not properly printed, steps 105 and 106 are repeated. If the color of the ink droplet is incorrect or abnormal, the print head may need to be replaced or cleaned.

After the correction and the trial printing, step 108 discharges ink droplets into the printing area 33 (FIG. 5D). Step 109 then imposes an electric field to homogenize the ink droplet 56. The electrode 22 can be integrated with the print head module 11 into one module so that it can be moved together with the print head module 11. After printing a certain distance depending upon the design, the electrode 22 imposes a voltage V. Of course, the electrode 22 can be designed as an independent module. See FIG. 5D, the ink droplet 56 from right to left is in the state of discharging, landing on the substrate 17, an electric field Y between the implanted electrode 21 and the electrode 22 is applied the ink droplet 56 to modulate the droplet surface, and finally, the ink droplet 56 spread out to the boundary, then the electric charge is removed. Electrodes 22 embedded in the system create a potential difference between implanted electrode 21 and the conducting ink fluid. The charges in the implanted electrode 21 attract the conducting fluid, reducing the tension of the interface between them.

Step 110 determines whether the last color is printed. Each color printing has to be corrected using the second optical module 10 to provide real-time corrections and adjustments, achieving an optimal accuracy. After the confirmation in step 110 is done, the shield wall 37 can be removed by chemical machinery polishing (CMP) 46 or etching process (step 111), as shown in FIG. 5E.

Finally, the color portion of the filter elements is colored and needs further curing process (step 112)(FIG. 5F). The method of light irradiation and heat treatment is used for curing depends on ink property. To advance cross-linking reaction by light or both light and heat, a photo-initiator (cross-linking agent) is employed. As cross-linking agent, bichromate, bisazide, radical initiator, cationic initiator, anionic initiator and the like is employed. Further, these photo-initiators are mixed or they are combined with other sensitizers. To further advance the cross-linking reaction, heating process is performed after irradiation of light.

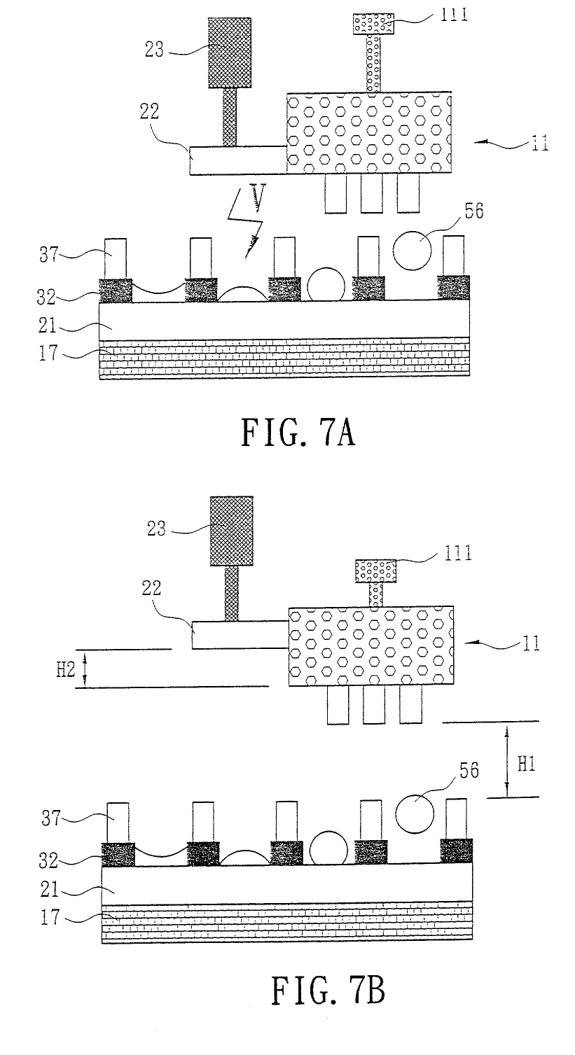

With reference to FIG. 7A, to adjust the height of the electrode 22 to change the electric field intensity, the electrode 22 can be installed with a height adjustment unit 23 to change its height H₂ from the bottom of the print head module 11. Similarly, the print head module 11 can be installed with a height adjustment unit 111, which changes the height H₁ of the print head, achieving an optimal painting.

Effects of the Invention

The invention relates to an inkjet manufacturing process and device for color filters. It has the following advantages:

1. The invention does not need the design of an ink absorption layer, decreasing the manufacturing process and cost. Since the ink droplets are modified by an applied electric field, they can be more homogeneously distributed.

2. The optical detection systems have light sources directly installed under the filter substrate; therefore, the invention does not have errors due to reflection as in the prior art.

3. The optical detection positioning adopts real-time detection positioning so that the ink printing is more accurate.

4. The optical detection is digital; therefore, the invention does not have errors due to shifts in troughs and crests as in the conventional means.

5. The optical detection systems are separate from the print head module, convenient for print head cleaning.

What is claimed is:

1. An inkjet device for color filters to print conductive ink droplets on a color filter substrate and to equalize distribution the ink droplets, which comprises:
a print head module having at least one nozzle and each color having a distinct print head for painting ink droplets on the color filter substrate;
a motion platform supporting the color filter substrate so that the substrate being able to have a relation motion with respect to the print head module;
an electric field generator imposing an electric field on the filter substrate with printed ink to produce the electrocapillary effect so as to equalize distribution the ink droplets;
an optical detection system detecting the relative positions of the color filter substrate and the nozzles; and
a control system controlling the print head module, the motion platform, the electric field generator and the optical detection system.

2. The device of claim 1, wherein the optical detection system detects a border track of a printing frame on the color filter substrate to ensure the relative positions of the filter substrate and the nozzles.

3. The device of claim 2, wherein the printing frame is a two-dimensional black matrix.

4. The device of claim 1, wherein the optical detection system uses a light source under the substrate, detecting the light intensity through the substrate to determine the relative positions of the color filter substrate and the nozzles.

5. The device of claim 1, wherein the electric field generator produces the electric field using an electric current selected from the group consisting of a direct current (DC) and an alternative current (AC).

6. The device of claim 1, wherein the electric field generator includes two electrodes with opposite polarities and the electrodes are installed both directions of the ink droplets.

7. The device of claim 6, wherein one of the electrodes is on one side of the print head module and the other electrode is installed on one surface of the substrate.

8. The device of claim 7, wherein the electrode on one side of the print head module is integrated together with the print head module.

9. The device of claim 8, wherein the electrode on one side of the print head module has a height adjustment unit, which adjusts the electrode and the substrate to change the relative distance between the electrode and the nozzle on the print head module.

10. The device of claim 9, wherein one of the electrodes is installed on one side of the print head module and the other electrode is installed on a bottom surface of the substrate.

11. The device of claim 1, wherein the print head module further comprises a height adjustment unit, which adjusts the relative distance between the print head module and the substrate.

12. An inkjet manufacturing process for color filters to print conductive ink droplets on a filter substrate and to homogeneously distribute the ink droplets, which comprises the steps of:
implanting an electrode on the filter substrate;
forming a printing frame on the filter substrate;
positioning the filter substrate and a nozzle;
discharging ink droplets into printing frame; and
imposing an electric field by the electrode on the ink droplets to equalize distribution the ink droplets.

13. The manufacturing process of claim 12, wherein the electrode is implanted on a surface of the filter substrate.

14. The manufacturing process of claim 12, wherein the electrode is implanted on a bottom surface of the filter substrate.

15. The manufacturing process of claim 12, wherein the filter substrate is further formed with a shielding wall on the printing frame to avoid ink droplet sputtering.

16. The manufacturing of claim 15 further comprising the step of removing the shielding wall after the ink droplets discharging onto the color filter substrate.

17. The manufacturing process of claim 12, wherein the printing frame is a two-dimensional black matrix.

18. The manufacturing process of claim 12, wherein the step of positioning the color filter substrate and a nozzle is achieved using a border track of the printing frame.

19. The manufacturing process of claim 12, wherein a curing step is included after the color filter substrate is printed with the ink droplets.

20. The manufacturing process of claim 19, wherein the curing is selected from the group consisting of vacuum, baking and UV curing.
